(19) United States
(12) Patent Application Publication
(10) Pub. No.: US 2013/0154366 A1
(43) Pub. Date: Jun. 20, 2013

(54) POWERING OF DEVICES

(71) Applicants: John Mark Counsell, Wirral (GB); Matthew John Stewart, Airdrie (GB); Andrew Williams, High Wycombe (GB)

(72) Inventors: John Mark Counsell, Wirral (GB); Matthew John Stewart, Airdrie (GB); Andrew Williams, High Wycombe (GB)

(73) Assignees: THE UNIVERSITY OF STRATHCLYDE, Glasgow, Strathclyde (UK); BUILDING RESEARCH ESTABLISHMENT LTD, Watford, Hertfordshire (UK)

(21) Appl. No.: 13/579,689

(22) PCT Filed: Feb. 21, 2011
(86) PCT No.: PCT/GB2011/050335

§ 371 Date: Feb. 28, 2013

(30) Foreign Application Priority Data
Feb. 19, 2010 (GB) 1002832.2

(51) Int. Cl. H02J 4/00

(52) U.S. Cl. CPC H02J 4/00
USPC 307/24

(57) ABSTRACT

Apparatus for powering devices, comprising a power supply having inputs from two or more different power sources; means for combining the power sources and providing a power supply to one or more end devices; means for comparing the two input power sources and generating an index representative of the relative proportions of each at any time and means for using the index to determine how the power is utilised.

This invention relates to the powering of devices. In particular, but not exclusively, it relates to a method and apparatus for providing power to and most efficiently using power at one or more end devices and in particular to most efficiently using energy derived from lower carbon sources at times when this is provided.

It is becoming more and more common to supplement mains power supplied to a building with locally provided sustainable energy sources, such as sources based upon photovoltaic (PV) energy (‘solar cell devices’), wind turbines, hydroelectric sources or other sustainable or ‘green’ sources. Additionally, it is becoming more common for the mains energy to have been at least partially generated by sustainable sources.

Often, both a mains supply and a sustainable supply are provided as power inputs to a building, a group of buildings or other locations, where they may be combined and used to power devices within the building.

The availability of sustainable power in these circumstances can vary throughout the day or other time periods. For example, PV sources only directly generate solar power when the sun is shining upon them or at least in a certain minimum ambient level of light. Wind turbines are of course very dependent upon prevailing wind speed, and so on. It is desirable to maximise the use of sustainable energy when this is available.

Many computers and similar devices can connect to networks via so-called Ethernet ports, and Ethernet or CATS cabling. It is also now possible to transmit power over Ethernet networks (known as Power Over Ethernet (POE) and to power relatively low power devices such as laptop computers, printers or other devices directly over the Ethernet network. This is convenient since it means that a device can simply be plugged into an Ethernet network and not require a separate power supply and mains supply. POE may, currently, typically be used to provide power requirements of up to about 33 watts.

The present invention arose in an attempt to provide an improved method of utilising sustainable power wherever possible.

According to the present invention there is provided apparatus for powering devices, comprising a power supply having inputs from two or more different sources; means for combining the sources and providing a power supply to one or more end devices; means for determining the relative amounts of the input sources comprised in the output power supply and generating an index representative thereof at any time, and means for using the index to determine how the power is utilised.

The means for using the index preferably comprises means for transmitting said index to the one or more end devices, and means associated with each end device for using the index to determine how the power is utilised.

The means for using the index may comprise a control means adapted to use the index to determine how the power is utilised. The means for using the index may be part of, or associated with, the control means and/or each end device. The control means may comprise means for calculating an error using the index and an input set-point value, and means associated with the control means and/or each end device for using the error to determine how the power is utilised. The control means may also receive feedback on the power usage from one or more of the end devices, where the control means are also adapted to use the feedback information to determine how the power is utilised.

The two sources may differ in the amount of carbon produced, in which case the index may be an index (so-called ‘Green Index’) of sustainable (renewable) power versus less sustainable power. Although it will not usually be a direct measure of carbon (in terms of, for example, Kg CO₂/second) it may in some embodiments represent this.

The index may be generated by using comparison means.

The index may be transmitted over the actual power transmission path or may separately transmit it. In embodiments where it is transmitted over the power transmission path, it may be transmitted over Ethernet, via mains signalling, via a wireless mechanism in which power is also transmitted wirelessly or by other mechanism.

Alternatively, the index may be transmitted, at least partially, over a separate transmission path to the power.

The power supply to the end devices may be an AC supply (eg two or more AC supplies and in one or more ‘combined’ AC supplies out).

Alternatively, the power supply to the end devices may be a DC supply. This may be provided from AC input sources (eg via rectifies or other AC/DC converters) or from all DC inputs or a combination of AC and DC inputs.

The end devices may be ones which include rechargeable batteries and the power utilisation means may be arranged to alter the way in which the battery is charged depending upon the proportions of different power in the power supply.

The end devices may be ones which include rechargeable batteries, monitors and processors, and the power utilisation means may be arranged to alter the way in which the battery is charged, the brightness of the screen, and the processor speed depending upon the proportions of different power in the power supply.

A plurality of end devices may be included. These are preferably, particularly in an Ethernet regime, supplied in a radial Ethernet network.

In one embodiment, the invention comprises a power supply unit, an index generator, the power supply unit being adapted to transmit power and the index to a router and the router adapted to provide power and the index over an Ethernet or other network to a plurality of devices. The router may act as a control means.

Other embodiments may comprise a power supply unit and an index generator, where the index generator is adapted to generate more than one index, and at least one generated index is designed to be transmitted to each end device.

More than one power supply unit may be provided, wherein an index generator is associated with each power supply unit, and wherein the index generators are designed to transmit an index to at least one end device. In these embodiments, one index may be a ‘Green’ index, and another index may be a ‘Cost’ index, where the ‘Cost’ index is calculated from power inputs of differing financial cost per kilowatt-hour, for example.

The means associated with each device may comprise a hardware means, a software means, or a combination of these.

According to the present invention in a further aspect, there is provided a method of using power, comprising providing two or more inputs from different power sources to a power supply, the supply being adapted to combine these as one or more outputs, generating an index relating to the relative proportions of the different sources input to the power source, and using the index to determine how the power is used.

The index is preferably provided to one or more devices using the power, and the index is preferably used at the devices to determine how the power is used.

Alternatively, the index may be provided to a control means associated with the one or more end devices, and the index is used at the control means and/or devices to determine how the power is utilised. The index may be compared to an input set-point value to generate an error, and the error may be used at the control means and/or devices to determine how the power is utilised. The control means may also be used for receiving feedback on power usage from the devices, and using the feedback information to determine how the power is utilised.

The power may be provided over Ethernet or similar cable systems.

The index may transmitted over the same power transmission line as the power, or separately.

At least one of the sources is preferably a source which is more sustainable than the other and the index is an index of the proportion of sustainable power.

One or more of the devices may include a rechargeable battery and the index used at least partially to determine a charging regime and/or balance between charging and directly power the device.

One or more of the devices may include a rechargeable battery, a monitor, and a processor. The index can be used to at least partially determine a charging regime, monitor brightness and processor speed, and/or determine a balance between these attributes and directly powering the device.

At least some of the devices may be adapted to be in communication with each other and/or with a further network device, are adapted to communicate to maximise use of particular types of power over the network. The further network device may be a control means.

Embodiments of the invention will now be described, by way of example only, with reference to the accompanying schematic drawings, in which:

FIG. 1 shows a power supply arrangement;

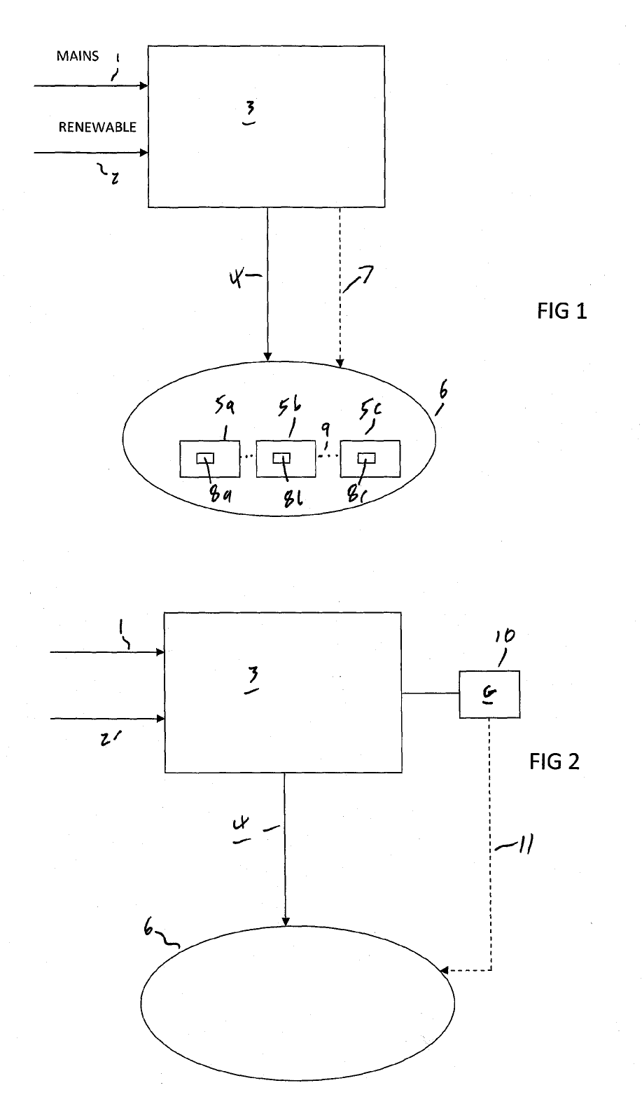

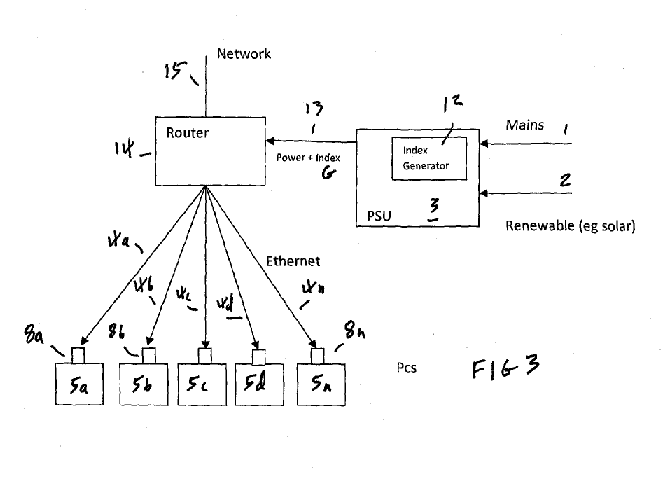

FIG. 2 shows an alternative power supply arrangement;

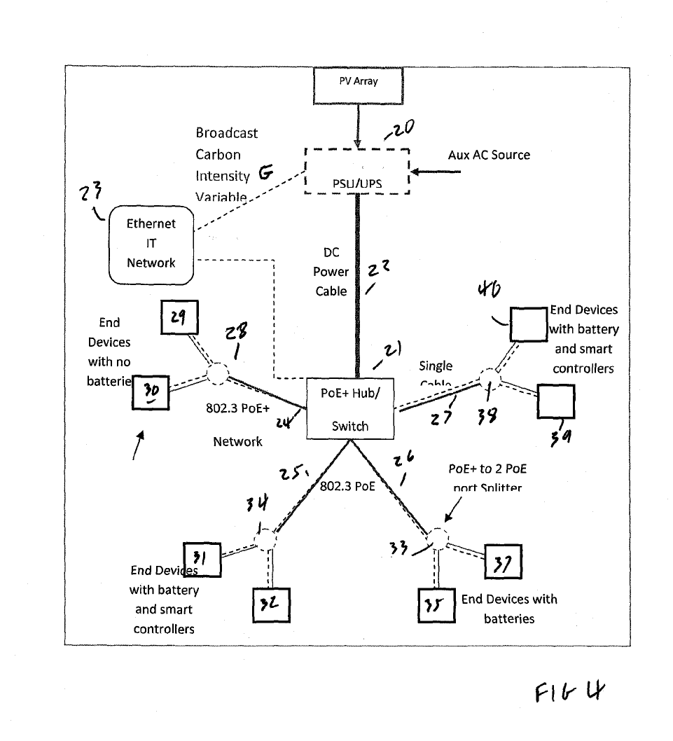

FIG. 3 shows a power over Ethernet arrangement; and

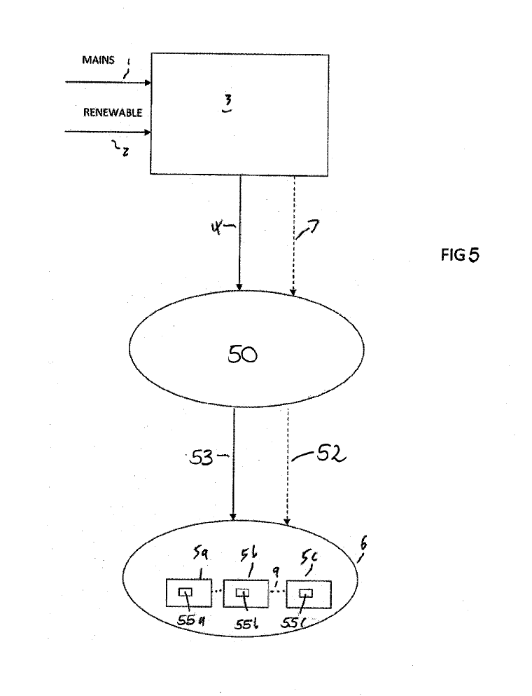

FIG. 4 shows an alternative arrangement;

FIG. 5 shows further alternative power supply arrangement.

Referring to the figures, FIG. 1 shows very schematically an embodiment of the invention. In this example, two different sources of power, labelled mains 1 and renewable 2, are input to the power supply 3. Note that in other embodiments there may be more than two power sources and these may be of many different types. The renewable source could be solar (photovoltaic (PV)) cells or similar, a wind turbine, a hydroelectric source or many other types and indeed in some embodiments it need not actually be a sustainable or low carbon source. It could be two different mains inputs or inputs from different locations.

The power supply 3 combines the two and provides one or more power outputs (of which only one is shown at 4) to one or more end devices 5, of which three, 5a, 5b and 5c, are shown by way of example only within a general schematic network 6 of devices.

The power supply 3 may, for example, be the power supply of a domestic building, school, office or so on and may comprise a meter and any convenient means for receiving two or more power inputs and providing one or more outputs derived from these. Thus, at any time, if renewable power is not available on line 2 then the power output will be solely derived from the mains in this embodiment. If the mains supply is not available, then the output will solely be derived from whatever is available from the renewable power source 2 and if both are available then a combination of these will be output.

The power supply also includes, or is associated with, a means for comparing the two or more inputs and for generating an index (typically a number, say from 0 to 1 or 1 to 10 although it may be within any desired range) of the relative proportions of these in the output power. This means is not specifically shown in the figure. The Index may alternatively, or in addition, be an actual measure of carbon, in Kg CO₂/second or other units in the output power.

This ‘Green’ Index G (where one of the sources is a renewable source) is transmitted to the end devices 5 and this is shown schematically by dashed line 7. For example, if at any time no renewable power is available (perhaps at times of total darkness) then the Green Index may be zero or a relatively low value. If at any time the renewable power is at maximum then it will be possible to solely output renewable power and therefore the Green Index will be one or a relatively higher value than when the renewable power is at a minimum. Generally, the index will fall somewhere between these extremes, since the output power will have a mixture of powers derived from the mains and from the local renewable source or sources.

The index is therefore a measure of how ‘green’ or sustainable the power actually supplied to end devices is at any stage. It is typically transmitted as a single number, perhaps 8, 16 or other bit number when it is transmitted digitally. The index could alternatively, of course, be transmitted in an analogue manner.

Each of the devices 5a to 5c (for example) include a means 8a, 8b, 8c, which receives the index and is adapted to be able to determine how the device uses the power supplied to it in accordance with the index. This may be a separate hardware device attached externally or internally on the device, a software application capable of using the device to alter the way the device uses power, computer firmware, or any combination of devices of this type. It may be a specific chip set within the device, for example.

By use of this additional element, the end devices 5a can use the ‘Green’ Index to determine how best to use the power, typically to minimise carbon (ie to maximise use of renewable sources). For example, if the battery of a device is low and the device is being used, but the index shows that power is mainly ‘dirty’, ie mainly from the mains, then the device may be powered to operate at a basic level but no battery charging occurs. If the energy supplied is ‘cleaner’ (higher index) then the battery may also be charged in addition to operating the device. Many different algorithms may be used to use different indices to run devices at optimum carbon saving levels.

Control may be based on one or more threshold values or the index being exceeded or not for example. It may be based on other parameters, however, such as minimum battery charge levels to be maintained, or many other parameters or combinations of parameters.

In some embodiments the individual devices 5 may be arranged to communicate with each other or a central server or other device (eg by schematic links 9) so as to interact in order to further optimise use of power according to different green indices. For example, if the power supply at any time is particularly dirty but a basic level of computing power for example, is required, then the devices may interact with each other to make sure that at least one of them is kept running, albeit at the minimum possible level, and that only devices for which it is essential that a battery be charged, be charged at that time.

It will be appreciated that many different scenarios will be possible.

The device of course need not be computer type devices. There may be many other types of devices or even larger appliances, such as white goods (refrigeration, washing machines, dishwashing machines, heating and/or air-conditioning apparatus and so on) or many other types of appliances or devices.

Most preferably, the Green Index is transmitted over the same transmission path as the power. Thus, if power is transmitted over a standard mains network, such as ring main, then by using known technology for signalling over mains cabling, the Green Index may also be transmitted therewith.

In some embodiments, the Green Index is transmitted, along with power, over an Ethernet or similar wired network (power over Ethernet) and FIG. 3 shows one non-limiting example of this. Alternatively, it may be possible to transmit both power and signals wirelessly, or by other means in which the signals are transmitted over the same path.

In other embodiments, the Green Index can be transmitted separately and independently to the end device. FIG. 2 shows this schematically. Again, mains 1 and renewable energy is provided to a power supply which outputs power 4 which a combination of these. This is supplied to a number of devices within a general network 6. A separate device 10 is adapted to be able to compare the relative amounts of inputs 1 and 2 and to generate a Green Index G which is transmitted over a separate transmission path 11 to each of the devices. Thus, if the devices are powered through conventional mains wiring system, then the Green Index may be transmitted through an Ethernet network, through wireless signalling, or through some other signalling method where it can be received by and acted upon by the individual devices shown within the network 6.

The index may alternatively be transmitted partly over the same transmission path and partly on a separate path.

FIG. 3 shows a power over Ethernet (POE) example. In this example, mains 1 and renewable 2 energy are input to a power supply unit 3 which includes an index generator 12. Power is output from this on a power supply line 5 which also has the Green Index G transmitted with it. The powers applied to a router 14 connected to a network 15 such as the Internet, via a modem for example that is well known. The router is connected to a number of devices 5a to 5n via Ethernet caballing 4a to 4n.

In a typical previously available Ethernet system, a ring-type arrangement is used. In embodiments of the present invention, it is preferred, but not essential, that the Ethernet be provided in an alternative radial structure in which a number of separate radial lines emanate from the router each to a particular device 5a, 5b, and so on. Alternatively, two or more devices can be connected to each spoke of the radial network. This is because in this arrangement, power is also being distributed from the router over the Ethernet to each device and the devices are being powered thereby. The radial arrangement ensures that sufficient power is available on each spoke to properly power the device, bearing in mind that current POE regime can transmit up to about 33 W. This is sufficient for a low power computing device. It is envisaged that with future developments the power capabilities of POE regime will increase and/or device power will decrease.

As shown, each device is associated with a means 8a to 8n (a ‘smart controller’) which may be a separate device which is plugged in, a chip set, software or so on. This can use the index transmitted with the power and other signals over the Ethernet network, in combination with the PC or other device and optionally in combination with other PCs in the network, to best utilise the power at any time depending upon the magnitude of the index.

FIG. 4 shows another version of the system of FIG. 3. In this case, the mains energy is from an auxiliary AC source 1 and the renewable from a PV array 2. This input 2 to a Power Supply Unit (PSU) 3 which may include an uninterruptable power supply (UPS). Note that a UPS may of course be provided in any embodiment. This provides power over a DC power cable 22 to a POE hub/switch 21. In the PSU is an index generator (not shown for clarity) and this broadcasts the index (wirelessly or via wired) linked to an Ethernet IT network shown generally as 23. The network is connected to the hub/switch 21 and includes the Green Index G.

The figure shows a number of spokes, 24, 25, 26 and 27 for example, of a radial Ethernet network. They operate in accordance with the 80.3 POE standard. Spoke 24 is connected to a port splitter 28 which in turn supplies two end devices 29 and 30. Spoke 25 is applied to a further splitter 29 which supplies two more devices 31 and 32 except these have, in addition to a battery, a smart controller which can utilise a Green Index signal. Note that in the figure the Green Index signal on the Ethernet spokes are shown as dashed lines and the power signals are shown as solid lines. Spoke 26 leads to a splitter 33 and from there to two end devices 35, 36 with batteries and spoke 27 leads to a splitter and to two end devices 39 and 40 which have batteries and smart controllers. The devices with smart controllers can utilise the Green Index to most efficiently use power as described. Thus, the Green Index is communicated to each device through the same cable that provides the power, ie the POE cable. This variable can be used by devices with a smart controller, typically using a controller of inverse proportionality, to set charge level on the battery of the device or otherwise determine power usage for example. Thus, if the carbon intensity is high the charge level for the battery is minimised and thus minimising power draw of the device. If the carbon intensity of power decreases, as more renewable power is available, the smart controllers battery charging set points are increased to allow maximum use of the ‘clean’ power.

FIG. 5 shows another version of the system of FIG. 1. In this case, the power supply 3 combines two different sources of power 1, 2 and provides a power output 4 and a ‘Green’ index 7 to a control means 50. The control means 50 are adapted to process the ‘Green’ index 7 to give a control signal 52 which determines how the power should be utilised by the end devices 5. The control means then transmit the control signal 52 along with one or more power outputs (of which only one is shown at 53) to one or more end devices 5, of which three, 5a, 5b and 5c, are shown by way of example only within a general schematic network 6 of devices. The end devices 5 are associated with a means 55a, 55b, 55c adapted to enable the devices to respond to the control signal 52.

In one embodiment, a set-point value is input into the control means 50. This set-point value is preferably the ideal ‘Green’ index for power utilisation. the control means 50 uses the input set-point value and the generated ‘Green’ index 7 to calculate an error, where the error corresponds to the difference between the ‘Green’ index 7 and the set-point value. The control means then transmit the calculated error as the control signal 52 to one or more end devices 5. In an alternative embodiment, the control means 50 uses the calculated error to produce the control signal 52.

In one embodiment, the control signal 52 is a ‘reduce power’ or other command transmitted to all end devices 5. In another embodiment, the control signal transmitted to a group of, or just one, end device(s) 5. In yet another embodiment, the end devices 5 are ‘addressable’ and the control means 50 sends a control signal 52 containing different instructions to each, or groups of, the end devices 5.

The control means may be provided as a separate device as shown in FIG. 5, or the control means 50 may be provided in the same device as the power supply 3.

Each controller device 8 (referring back to FIGS. 1 to 3, although also applicable to FIGS. 4 and 5 and other embodiments) can reside inside an end device or in a box outside that device and can therefore be retrofitted to existing equipment in some embodiments.

In some versions, ‘smart controllers’ may be provided which are separate units which can plug into a computer or other device, eg by a USB port, or be connected to it via a cable or wireless link. Alternatively, a ‘smart controller’ may form part of, or be connected to or associated with a docking station or port-replicators, into which laptop computers or other devices can be connected. This is a convenient way of producing smart controllers on a network without requiring modifications to existing computers. More than one computer can of course be connected to or acted upon by a single smart-controller in some embodiments. The computers and/or smart controllers may interact with each other for load balancing, network-based power or energy use and/or other reasons.

The main embodiments described relate to DC powered systems, such as POE. Thus, in FIG. 3 the PSU 3 may include AC/DC conversion means (known in themselves) for outputting a DC signal to the router 14. Alternatively, the router may receive AC and have an AC/DC converter built in or otherwise associated with it.

In an alternative embodiment, the end device may be AC powered, such as AC powered IT equipment, heating/cooling/ventilation apparatus, entertainment devices such as TVs or other equipment. In such cases, the power supplied to them will be AC power.

It is also possible that some end device may be AC powered and other, DC powered, so that an AC supply with local AC/DC converters will be appropriate.

The invention is equally applicable to use in not just a single building, but to groups of buildings, such as those on a campus or industrial plant, a group of residential houses and/or apartments, a street or any other community.

1. Apparatus for powering devices, comprising a power supply having inputs from two or more different sources; means for combining the sources and providing a power supply to one or more end devices; means for determining the relative amounts of the input sources comprised in the output power supply and generating an index representative thereof at any time, and means for using the index to determine how the power is utilised.

2. Apparatus as claimed in claim 1, wherein the means for using the index comprises means for transmitting said index to the one or more end devices, and means associated with each end device for using the index to determine how the power is utilised.

3. Apparatus as claimed in claim 1, wherein the means for using the index comprises control means associated adapted to use the index to determine how the power is utilised.

4. Apparatus as claimed in claim 3, wherein the control means comprises means for calculating an error using the index and an input set-point value, and means associated with the control means and/or each end device for using the error to determine how the power is utilised.

5. Apparatus as claimed in claim 3, wherein the control means receives feedback on the power usage from one or more end devices, wherein the control means are adapted to use the feedback information to determine how the power is utilised.

6. Apparatus as claimed in claim 1, wherein the power supply inputs differ in the amounts of carbon generated and the index is a ‘Green’ Index.

7. Apparatus as claimed in claim 1, wherein the index is generated by using comparison means.

8. Apparatus as claimed in claim 1, wherein the index is transmitted over the same transmission path as the power.

9. Apparatus as claimed in claim 8, wherein the index and power are transmitted over Ethernet cabling.

10. Apparatus as claimed in claim 9, wherein the Ethernet system is a radial one.

11. Apparatus as claimed in claim 1, wherein the index is transmitted at least partially over a separate transmission path to the power.

12. Apparatus as claimed in claim 1, wherein the end devices include rechargeable batteries.

13. Apparatus as claimed in claim 1, wherein the index is used to determine an appropriate balance between charging the battery and powering the device.

14. Apparatus as claimed in claim 1, wherein at least some of the end devices are communicable with each other or to a server in order to interact with each other to use the index.

15. Apparatus for power devices comprising a power supply unit, an index generator, the power supply unit being adapted to transmit power and the index to a router, and the router adapted to provide power and the index over a cabling system to a plurality of devices.

16. Apparatus as claimed in claim 1, wherein the means associated with each device for using the index comprises a hardware means, a software means or a combination of these.

17. Apparatus as claimed in claim 1, wherein the index is a measure of carbon.

18. A method of using power, comprising providing two or more inputs from different power sources to a power supply, the supply being adapted to combine these as one or more outputs, generating an index relating to the relative proportions of the different sources input to the power source, and using the index to determine how the power is used.

19. A method of using power as claimed in claim 18, comprising providing the index to one or more devices using the power, and using the index at the devices to determine how the power is used.

20. A method of using power as claimed in claim 18, comprising providing the index to a control means associated with the one or more end devices, and using the index at the control means and/or devices to determine how the power is utilised.

21. A method of using power as claimed in claim 20, comprising comparing the index to an input set-point value to generate an error, and using the error at the control means and/or devices to determine how the power is utilised.

22. A method of using power as claimed in claim 18, comprising receiving feedback on power usage from the devices, and using the feedback information to determine how the power is utilised.

23. A method as claimed in claim 18, wherein the index is transmitted over the same transmission path as the power.

24. A method as claimed in claim 18, wherein the index and the power are transmitted over an Ethernet or other cable system.

25. A method as claimed in claim 18, wherein at least one of the sources is a source which is more sustainable than the other and the index is an index of the proportion of sustainable power.

26. A method as claimed in claim 24, wherein the power is transmitted at least partly on a path which differs from the index.

27. A method as claimed in claim 18, wherein one or more of the devices includes a rechargeable battery and the index is used to determine a charging regime and/or balance between charging and directly power the device.

28. A method as claimed in claim 24, wherein at least some of the devices are adapted to be in communication with each other and/or with a further network device.

29. (canceled)

30. (canceled)
